(19) United States
(12) Patent Application Publication
(10) Pub. No.: US 2019/0297496 A1
(43) Pub. Date: Sep. 26, 2019

(54) OPERATION METHOD OF COMMUNICATION NODE FOR ACCESS CONTROL IN MULTI-HOP BASED COMMUNICATION NETWORK

(71) Applicant: Electronics and Telecommunications Research Institute, Daejeon (KR)

(72) Inventor: Young Ho KIM, Daejeon (KR)

(73) Assignee: Electronics and Telecommunications Research Institute, Daejeon (KR)

(21) Appl. No.: 16/351,860

(22) Filed: Mar. 13, 2019

(30) Foreign Application Priority Data
Mar. 23, 2018 (KR) 10-2018-0033788

(51) Int. Cl. H04W 12/06; H04W 80/02; H04W 48/16

(52) U.S. Cl. CPC H04W 12/06; H04W 84/18; H04W 48/16; H04W 80/02

(57) ABSTRACT

An operation method of a first communication node performing access control in a multi-hop based communication network may comprise receiving a first message requesting authentication for a third communication node from a second communication node included in the communication network; transmitting a second message requesting authentication for the third communication node to a fourth communication node performing an authentication procedure in the communication network; receiving a third message from the fourth communication node, the third message including information on a result of the authentication procedure for the third communication node; and transmitting a fourth message including the information on the result of the authentication procedure to the second communication node.

### CROSS-REFERENCE TO RELATED APPLICATIONS

This application claims priority to Korean Patent Application No. 10-2018-0033788 filed on Mar. 23, 2018 in the Korean Intellectual Property Office (KIPO), the entire contents of which are hereby incorporated by reference.

### BACKGROUND

### 1. Technical Field

The present disclosure relates to an operation method of a communication node for access control in a multi-hop based communication network, and more specifically, to an operation method of a communication node supporting a medium access control (MAC) level authentication procedure in a multi-hop based communication network.

### 2. Related Art

According to a medium access control (MAC) level access control technique in a communication network in which wireless communication is performed, a new communication node desiring to access the communication network may perform an access request to a communication node capable of performing authentication (e.g., authentication node). Thereafter, the communication node capable of authenticating in the communication network may determine whether or not to allow access of the new communication node based on the authentication result for the new communication node. In this case, the authentication for the new communication node in the communication network may be performed in an authentication server, and the detailed procedure for performing the authentication may use various techniques such as EAP-TLS, EAP-MD5 and DAP-PEAP according to security strength and usage.

That is, the new communication node desiring to access the communication network may not be able to access network resources shared in the communication network until an access permission is given from the communication node that has performed the authentication by successfully completing the authentication procedure. In other words, in order to transmit or receive data through a global network such as the Internet, the new communication node may preferentially access the communication node capable of performing authentication within its own wireless communication radius. In this process, the new communication may perform the access under the access control by the communication node capable of performing the authentication. Here, the wireless communication may mean frame-by-frame communication at the MAC level.

A procedure for authenticating a new communication node in the communication network to determine whether or not to allow the access of the new communication node may include a step of requesting access to a communication node capable of performing authentication by a new communication node desiring to access the communication network, a step of performing an authentication procedure for the new communication node by an authentication server; a step of receiving an authentication result and an access permission result from the authentication server; and a step of controlling to receive or flow out data traffic for the new communication node based on an access control boundary.

The authentication procedure for the new communication node and the procedure for determining whether or not to permit access to the communication network performed through such the method may be procedures performed in case of a single-hop based communication network. That is, the above-described authentication procedure and the procedure for determining whether or not to permit the access may be applied only to the new communication node within the wireless communication radius of the communication node capable of performing authentication. In other words, there is a problem that the above-described authentication procedure and the procedure for determining whether or not to permit the access cannot be applied to a multi-hop based communication network such as a wireless sensor network based on a routing protocol for low-power and lossy network (RFC 6550 RPL).

Specifically, in the multi-hop based communication network, an access control technique such as a protocol for carrying authentication for network access (RFC 5191 PANA) operable on the Internet protocol (IP) may be applied to the authentication procedure and the procedure for determining whether or not to permit the access. In the communication network to which the access control technique is applied in this manner on an upper layer protocol, when the authentication procedure is not successfully performed based on the communication node capable of performing authentication, communication that passes through the access control boundary cannot be performed. In this case, the communication node performing the authentication procedure may implement access control based on a coordinator.

Accordingly, the authentication node performing authentication in the communication network may determine that the communication node for which the authentication has failed based on the access control boundary is a potentially malicious communication node, and may block traffic from the determined communication node. However, there is a problem that the communication node performing authentication in the multi-hop based communication network cannot control attack traffic targeting other communication nodes without passing through itself. Such the problem may arise because the authentication procedure and the procedure for determining whether to permit access in the multi-hop based communication network are not performed at the MAC level.

### SUMMARY

Accordingly, embodiments of the present disclosure provide an operation method of a communication node for supporting MAC level authentication in a multi-hop based communication network.

In order to achieve the objective of the present disclosure, an operation method of a first communication node performing access control in a multi-hop based communication network may comprise receiving a first message requesting authentication for a third communication node from a second communication node included in the communication network; transmitting a second message requesting authentication for the third communication node to a fourth communication node performing an authentication procedure in the communication network; receiving a third message from the fourth communication node, the third message including information on a result of the authentication procedure for the third communication node; and transmitting a fourth message including the information on the result of the authentication procedure to the second communication node.

The first communication node may be a primary trust head performing a plurality of functions for the authentication procedure in the communication network.

The second communication node may be a secondary trust head performing at least one preconfigured function among a plurality of functions for the authentication procedure in the communication network.

The second communication node may be a communication node for which an authentication procedure in the communication network has been completed in advance, and which is connected to the communication network.

The third communication node may be a new communication node transmitting a message requesting access to the communication network to the second communication node.

The fourth communication node may be an authentication server for performing the authentication procedure for the third communication node in the communication network.

In order to achieve the objective of the present disclosure, an operation method of a first communication node performing access control in a multi-hop based communication network may comprise receiving a first message requesting access to the communication network from a second communication node; transmitting a second message requesting authentication for the second communication node to a third communication node performing an authentication procedure; receiving a third message from the third communication node, the third message including information on a result of the authentication procedure; and determining whether to allow the second communication node to access the communication network based on the information on the result of the authentication procedure.

The first communication node may be a secondary trust head performing at least one preconfigured function among a plurality of functions for the authentication procedure in the communication network.

The first communication node may communicate with the third communication node based on a medium access control (MAC) level authentication protocol.

The second communication node may be a new communication node transmitting the first message requesting access to the communication network to the first communication node.

The third communication node may be a primary trust head performing a plurality of functions for the authentication procedure in the communication network.

In the determining, when the authentication for the second communication node is successful, the second communication node may be determined to be allowed to access the communication network.

In the determining, when the authentication for the second communication node is not successful, the second communication node may be determined to be not allowed to access the communication network.

In order to achieve the objective of the present disclosure, an operation method of a first communication node performing an access procedure in a multi-hop based communication network may comprise discovering a second communication node to which access to the communication network is to be requested among a plurality of communication nodes included in the communication network; transmitting a first message requesting access to the communication network to the discovered second communication node; and receiving a second message including information on whether or not the first communication node is allowed to access the communication network from the second communication node.

The second communication node may be a secondary trust head performing at least one preconfigured function among a plurality of functions for the authentication procedure in the communication network.

In the discovering, a plurality of communication nodes located within a radius of a wireless communicable of the first communication node may be attempted to be discovered.

The wireless communication may be a medium access control (MAC) level frame-by-frame communication performed in the communication network.

The second message may include one of an indicator that allows the access to the communication network and an indicator that does not allow the access to the communication network.

According to the embodiments of the present disclosure, there is an effect of improving security by performing the authentication procedure and the procedure for determining whether to permit access through a MAC-level access control in the multi-hop communication network. In particular, the operation method of a communication node according to the present disclosure is capable of blocking attack traffic generated from a malicious communication node in the multi-hop-based communication network, thereby applying a more detailed security policy. Also, since the operation method according to the present disclosure can be applied through software implementation without burden of additional hardware, it is made possible to secure high security without burden of cost.

### BRIEF DESCRIPTION OF DRAWINGS

Embodiments of the present disclosure will become more apparent by describing in detail embodiments of the present disclosure with reference to the accompanying drawings, in which:

FIG. 1 is a block diagram illustrating a communication for access control in a communication network;

FIG. 2 is a conceptual diagram illustrating an operation method of a communication node for access control in a communication network;

FIG. 3 is a sequence chart illustrating an operation method of a communication node for access control in a communication network;

FIG. 4 is a conceptual diagram illustrating a multi-hop based communication network;

FIG. 5 is a conceptual diagram illustrating a case where attack traffic is generated in a multi-hop based communication network;

FIG. 6 is a sequence chart illustrating an operation method of a communication node for access control in a multi-hop based communication network according to an embodiment of the present disclosure;

FIG. 7 is a conceptual diagram illustrating an operation method of a communication node for access control in a multi-hop based communication network according to an embodiment of the present disclosure; and

FIG. 8 is a conceptual diagram illustrating protocol stacks for access control in a multi-hop based communication network according to an embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

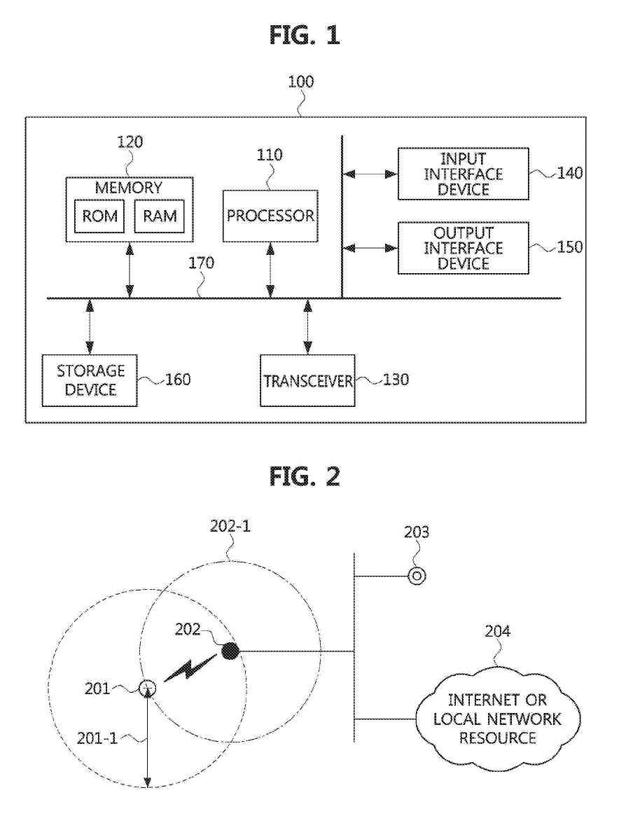

FIG. 1 is a block diagram illustrating a communication for access control in a communication network.

Referring to FIG. 1, a communication node 100 may comprise at least one processor 110, a memory 120, and a transceiver 130 connected to a network for performing communications. Also, the communication node 100 may further comprise an input interface device 140, an output interface device 150, a storage device 160, and the like. Each component included in the communication node 300 may communicate with each other as connected through a bus 170. However, each component included in the communication node 100 may not be connected to the common bus 170 but may be connected to the processor 110 via an individual interface or a separate bus. For example, the processor 110 may be coupled to at least one of the memory 120, the transceiver 130, the input interface device 140, the output interface device 150, and the storage device 160 via a dedicated interface.

The processor 110 may execute program commands stored in the memory 120 and/or the storage device 160. The processor 110 may refer to a central processing unit (CPU), a graphics processing unit (GPU), or a dedicated processor on which methods in accordance with embodiments of the present disclosure are performed. Each of the memory 120 and the storage device 160 may be constituted by at least one of a volatile storage medium and a non-volatile storage medium. For example, the memory 120 may comprise at least one of read-only memory (ROM) and random access memory (RAM). Here, the program executed through the processor 110 may include a plurality of steps for performing an operation method of a communication node in a communication network proposed by the present disclosure.

FIG. 2 is a conceptual diagram illustrating an operation method of a communication node for access control in a communication network.

Referring to FIG. 2, a communication network may include a plurality of communication nodes. Specifically, the communication network may include a first communication node 201, a second communication node 202, a third communication node 203, and a fourth communication node 204. Each of the first communication node 201, the second communication node 202, the third communication node 203 and the fourth communication node 204 included in the communication network may have a structure identical or similar to the structure of the communication node described with reference to FIG. 1.

Here, the first communication node 201 may be a new communication node (referred to as a ‘supplicant node (SN)’ in the present disclosure) desiring to access the communication network. Also, the second communication node 202 may mean a communication node (referred to as an ‘authentication node (AN)’ in the present disclosure) capable of supporting an authentication procedure for the first communication node 201. Also, the third communication node 203 may mean a communication node (referred to as an authentication server (AS)’ in the present disclosure) capable of performing the authentication procedure, and the fourth communication node 204 may mean a communication node (referred to as a ‘post authentication network (PN)’ in the present disclosure) included in the Internet or a local network which is a shareable network resource.

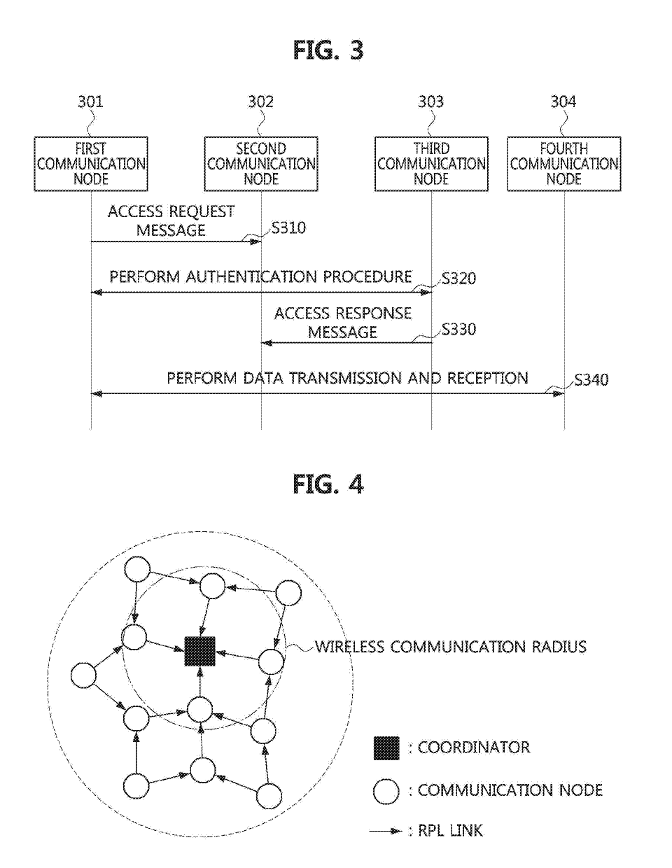

In this case, the first communication node 201 may perform discovery of a communication node capable of supporting the authentication procedure among a plurality of communication nodes existing within a wireless communication radius 201-1 of the first communication node 201, and may discover the second communication node 202 capable of supporting the authentication procedure through the discovery. The first communication node 201 may then perform an access procedure for the communication network via the searched second communication node 202. On the other hand, the second communication node 202 may perform access control for at least one communication node attempting to access the communication network within an access control boundary 202-1 of the second communication node 202. Hereinafter, a method in which the access control is performed in the communication network described with reference to FIG. 2 will be specifically described with reference to FIG. 3.

FIG. 3 is a sequence chart illustrating an operation method of a communication node for access control in a communication network.

Referring to FIG. 3, a communication network may include a first communication node 301, a second communication node 302, a third communication node 303, and a fourth communication node 304. Here, the first communication node 301 may mean the first communication node 201 described with reference to FIG. 2. That is, the first communication node 301 may refer to a new communication node desiring to access the communication network. Also, the second communication node 302 may mean the second communication node 202 described with reference to FIG. 2. That is, the second communication node 302 may refer to a communication node capable of supporting the authentication procedure for the first communication node in the communication network. Also, the third communication node 303 may mean the third communication node 203 described with reference to FIG. 2. That is, the third communication node 303 may refer to a communication node capable of performing the authentication procedure in the communication network. Also, the fourth communication node 304 may mean the fourth communication node 204 described with reference to FIG. 2. That is, the fourth communication node 304 may refer to a communication node included in the Internet or a local network that is a shareable network resource.

First, in the communication network, the first communication node 301 may search for the second communication node capable of performing an authentication procedure for an access procedure of the communication network among a plurality of communication nodes existing within a wireless communication radius. Then, the first communication node may generate an access request message requesting access to the communication network. Thereafter, the first communication node 301 may transmit the generated access request message to the second communication node 302 (S310).

Accordingly, the second communication node 302 may receive the access request message from the first communication node 301 requesting access to the communication network. The second communication node 302 may then generate an authentication request message requesting authentication for the first communication node 301. The second communication node 302 may then transmit the generated authentication request message to the third communication node 303. Accordingly, the third communication node 303 may receive the authentication request message requesting authentication for the first communication node 301 from the second communication node 302.

Thereafter, the third communication node 303 may perform an authentication procedure for determining whether or not to allow the first communication node 301 to access the communication network (S320). Specifically, the third communication node 303 may determine whether to allow the first communication node 301 to access the communication network based on the result of the authentication procedure for the first communication node 301. For example, the third communication node 303 may determine to allow the first communication node 301 to access the communication network when the result of the authentication procedure for the first communication node 301 is successful. On the other hand, the third communication node 303 may determine not to allow the first communication node 301 to access the communication network when the result of the authentication procedure for the first communication node 301 is a failure.

Then, the third communication node 303 may generate an access response message including information on the result of the authentication procedure. The third communication node 303 may then transmit the generated access response message to the second communication node 302. That is, the access response message may include an indicator that allows the access to the communication network when the result of the authentication procedure for the first communication node is successful. On the other hand, the access response message may include an indicator that does not allow the access to the communication network when the result of the authentication procedure for the first communication node is a failure.

Accordingly, the second communication node 302 may receive the access response message from the third communication node 303. Here, although not shown in FIG. 3, the second communication node 302 may transmit, to the first communication node 301, information on whether or not the first communication node 301 is allowed to access the communication network. For example, the second communication node 302 may generate an access response message including information on whether or not the first communication node 301 is allowed to access the communication network. The second communication node 302 may then transmit the generated access response message generated to the first communication node 301. In this way, the first communication node 301 may obtain the information on whether or not the access to the communication network is allowed from the access response message received from the second communication node 302. Then, the first communication node 301 may confirm whether or not access to the communication network is allowed by checking the obtained information. Thereafter, the first communication node 301 may perform transmission and/or reception of data through the fourth communication node 304 when the access to the communication network is allowed (S340).

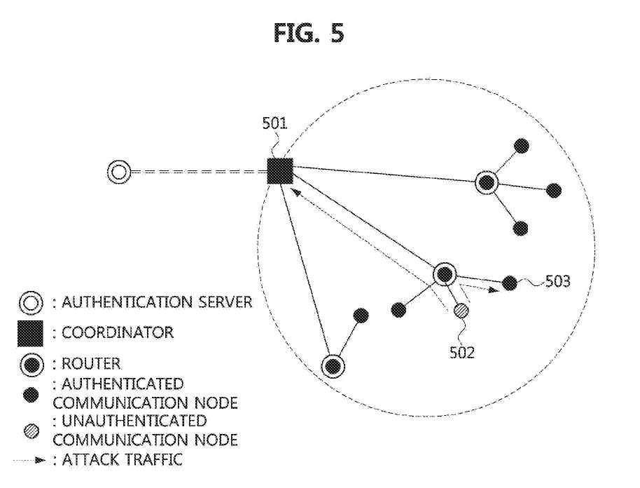

Access control for a new communication node desiring to access the communication network may be performed based on the authentication procedure through the above-described method. Meanwhile, the above-described method may be applied to a single-hop based communication network, and such the method may not be applied to a multi-hop based communication network. For example, a multi-hop based communication network will be specifically described with reference to FIGS. 4 and 5 below.

FIG. 4 is a conceptual diagram illustrating a multi-hop based communication network, and FIG. 5 is a conceptual diagram illustrating a case where attack traffic is generated in a multi-hop based communication network.

Referring to FIG. 4, a multi-hop based communication network may include a plurality of communication nodes. For example, the plurality of communication nodes may include a coordinator and at least one communication node performing an authentication procedure and an access procedure through the coordinator.

Specifically, in the multi-hop based communication network, the plurality of communication nodes may be interconnected based on a routing protocol for low power and lossy network (i.e., RFC 6550 RPL) link. In this case, the coordinator among the plurality of communication nodes in the multi-hop based communication network may perform access control (e.g., authentication procedure and access procedure) on a plurality of communication nodes located within a wireless communication radius of the coordinator. On the other hand, in the multi-hop-based communication network, access control on a plurality of communication nodes that are not located within the wireless communication radius of the coordinator may not be performed by the coordinator.

Referring to FIG. 5, a multi-hop based communication network may include a plurality of communication nodes. For example, the plurality of communication nodes may include an authentication server, a coordinator 501, at least one router, at least one unauthenticated communication node 502, and a plurality of authenticated communication nodes 503.

Specifically, the multi-hop based communication network may use an access control technique such as a protocol for carrying authentication for network access (i.e., RFC 5191 RANA) which is operable on an IP protocol stack. Also, authentication procedures and access procedures for a plurality of communication nodes included in the multi-hop based communication network may be performed through control of the coordinator 501.

Accordingly, the multi-hop based communication network may form an access control boundary through the coordinator 501. The access control boundary formed by the coordinator 501 in such the multi-hop based communication network may include at least one unauthenticated communication node 502 and the plurality of authenticated communication nodes 503. Here, the unauthenticated communication node 502 in the multi-hop based communication network may transmit attack traffic to the coordinator 501 or the plurality of authenticated communication nodes 503 through the router. That is, since the unauthenticated communication node 502 in the multi-hop-based communication network does not perform communication through the coordinator 501 forming the access control boundary, the communication node 502 may transmit attack traffic to the plurality of communication nodes included in the multi-hop based communication network.

According to an operation method of a communication node for access control in a multi-hop based communication network according to the present disclosure, attack traffic transmittable in the multi-hop based communication network can be blocked in advance, and the access control can be performed based on a MAC-level authentication protocol for a plurality of communication nodes in the multi-hop based communication network.

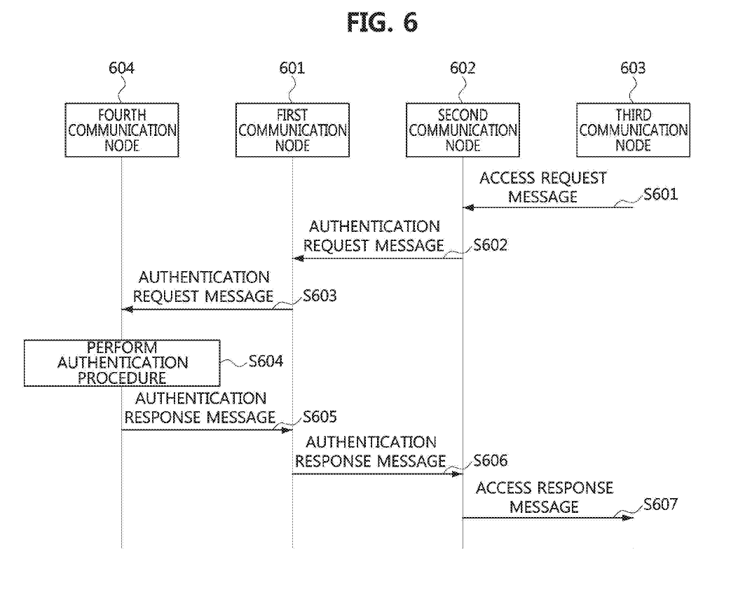

FIG. 6 is a sequence chart illustrating an operation method of a communication node for access control in a multi-hop based communication network according to an embodiment of the present disclosure.

Referring to FIG. 6, a multi-hop based communication network according to an embodiment of the present disclosure may include a first communication node 601, a second communication node 602, a third communication node 603, and a fourth communication node 604. For example, the first communication node 601 may mean a new communication node desiring to access the communication network. Also, the second communication node 602 may mean a secondary trust head performing at least one preconfigured function among a plurality of functions for the authentication procedure in the communication network. Also, the second communication node 602 may be a communication node that has already completed the authentication procedure in the communication network and is connected to the communication network. Also, the third communication node 603 may mean a primary trust head performing a plurality of functions for the authentication procedure in the communication network. That is, at least one preconfigured function performed in the second communication node 602 may be at least one of the plurality of functions performed in the third communication node 603. In addition, the fourth communication node 604 may refer to an authentication server that performs the authentication procedure for a communication node requesting access to the communication network.

First, when a need for access to the communication network occurs, the first communication node 601 may attempt to discover a communication node capable of supporting the authentication procedure among the plurality of communication nodes existing within the wireless communication radius of the first communication node 601, and discover the second communication node 602 capable of supporting the authentication procedure. Here, the wireless communication radius of the first communication node 601 may mean a radius within which the first communication node 601 can perform wireless communication. For example, the wireless communication may refer to a MAC-level frame-by-frame communication performed in the communication network. Then, the first communication node 601 may generate an access request message requesting access to the communication network. Thereafter, the first communication node 601 may transmit the generated access request message to the second communication node 602 (S601).

Accordingly, the second communication node 602 may receive the access request message requesting access to the communication network from the first communication node 601. The second communication node 602 may then generate an authentication request message requesting authentication for the first communication node 601 to determine whether to allow the first communication node 601 to access the communication network. Thereafter, the second communication node 602 may transmit the generated authentication request message to the third communication node 603 (S602).

Accordingly, the third communication node 603 may receive the authentication request message requesting authentication for the first communication node 601 from the second communication node 602. The third communication node 603 may then request authentication for the first communication node 601 to the fourth communication node 604 capable of performing the authentication procedure for the first communication node 601.

Specifically, the third communication node 603 may generate an authentication request message requesting authentication for the first communication node 601. Then, the third communication node 603 may transmit the generated authentication request message to the fourth communication node 604 (S603).

Accordingly, the fourth communication node 604 may receive the authentication request message requesting authentication for the first communication node 601 from the third communication node 603. Thereafter, the fourth communication node 604 may perform the authentication procedure for the first communication node 601 (S604). Here, the authentication procedure for the first communication node 601 may refer to an authentication procedure for determining whether to allow access to the communication network. Here, the fourth communication node 604 may obtain a result of the authentication procedure for the first communication node 601 through the authentication procedure. For example, the result of the authentication procedure may include an indicator indicating success of the authentication procedure or an indicator indicating a failure of the authentication procedure.

Then, the fourth communication node 604 may generate an authentication response message including information on the result of the authentication procedure. Then, the fourth communication node 604 may transmit the generated authentication response message to the third communication node 603 (S605). That is, the authentication response message may include an indicator indicating that authentication for the first communication node 601 is successful when the authentication for the first communication node 601 is successful. On the other hand, the authentication response message may include an indicator indicating that the authentication for the first communication node 601 fails when the authentication for the first communication node 601 fails.

Thereafter, the second communication node 602 may receive the authentication response message from the third communication node 603. Here, the second communication node 602 may obtain information on the result of the authentication procedure for the first communication node 601 from the authentication response message received from the third communication node 603. The second communication node 602 may then determine whether or not the first communication node 601 is allowed to access the communication network based on the information on the result of the authentication procedure.

For example, when the information on the result of the authentication procedure includes an indicator indicating that the authentication is successful, the second communication node 602 may determine that the access of the first communication node 601 to the communication network is allowed. On the other hand, when the information on the result of the authentication procedure includes an indicator indicating that the authentication fails, the second communication node 602 may determine that the first communication node 601 is not allowed to access the communication network.

The second communication node 602 may then inform the first communication node of whether or not the access of the first communication node 601 to the communication network is allowed. Specifically, the second communication node 602 may generate an access response message including information on whether or not the first communication node 601 is allowed to access the communication network. Then, the second communication node 602 may transmit the generated access response message to the first communication node 601 (S607).

Accordingly, the first communication node 601 may receive the access response message from the second communication node 602 in response to the access request message. That is, the first communication node 601 may receive a connection response message including information on whether or not the communication network is allowed to be accessed from the second communication node 602. The first communication node 601 may then obtain information on whether or not the first communication node 601 is allowed to access the communication network from the access response message received from the second communication node 602. Then, the first communication node 601 may confirm whether or not the access to the communication network is allowed based on the obtained information.

Meanwhile, in the operation method described with reference to FIG. 6, although the procedure for determining whether or not to allow a new communication node to access the communication network has been described as performed by the second communication node (i.e., the communication node acting as the secondary trust head), embodiments of the present disclosure are not limited thereto. In other words, in the method according to the embodiments of the present disclosure, the procedure for determining whether or not a new communication node is allowed to access the communication network may be performed by the third communication node (i.e., the communication node acting as the primary trust head) or the fourth communication node (i.e., the communication node acting as the authentication server).

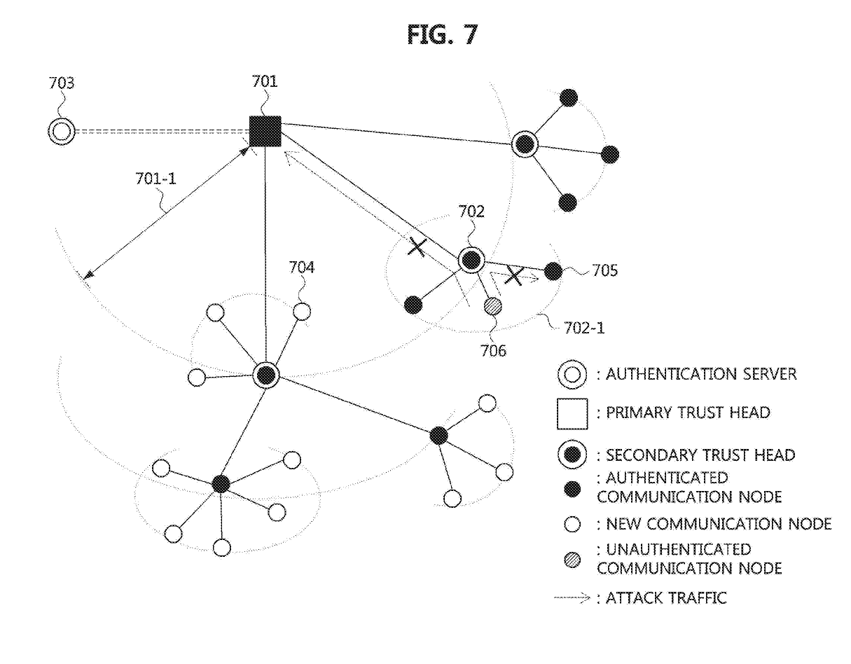

Through the above-described methods, access control on a new communication node desiring to access a multi-hop based communication network may be performed. That is, a communication node for which the authentication procedure has been completed in advance may perform at least one preconfigured function among a plurality of functions for the authentication procedure. Accordingly, the multi-hop based communication network according to the embodiment of the present disclosure can block attack traffic that can be transmitted from an unauthorized communication node. In this regard, a case where attack traffic is generated in the multi-hop based communication network and a case where the generated attack traffic can be blocked will be described in detail with reference to FIG. 7.

FIG. 7 is a conceptual diagram illustrating an operation method of a communication node for access control in a multi-hop based communication network according to an embodiment of the present disclosure.

Referring to FIG. 7, a multi-hop based communication network according to an embodiment of the present disclosure may include a primary trust head 701, at least one secondary trust head 702, an authentication server 703, a new communication node 704, a plurality of authenticated communication node 705, and at least one unauthenticated communication node 706.

Specifically, in the multi-hop based communication network of the present disclosure, the primary trust head 701 may perform a plurality of functions for the authentication procedure. Also, the secondary trust head 702 may perform at least one preconfigured function among the plurality of functions performed for the authentication procedure in the primary trust head 701.

For example, in the multi-hop based communication network, the primary trust head 701 may perform access control for communication nodes located within a wireless communication radius of the primary trust head 701. That is, when the primary trust head 701 receives an access request message from a communication node located within the wireless communication radius of the primary trust head 701, the primary trust head 701 may determine whether to allow access to the communication network through the authentication procedure for the corresponding communication node. In this way, in the multi-hop-based communication network, the primary trust head 701 may perform access control for the communication node located within the wireless communication radius of the primary trust head 701, thereby providing an access control boundary 701-1.

Also, in the multi-hop-based communication network, the secondary trust head 702 may perform access control for communication nodes that are not located within the wireless communication radius of the primary trust head 701. Specifically, the secondary trust head 702 may perform access control for the communication node located within a wireless communication radius of the secondary trust head 702. That is, when the secondary trust head 702 receives an access request message from a communication node located within the wireless communication radius of the secondary trust head 702, the secondary trust head 702 may determine whether to allow access to the communication network through the authentication procedure for the corresponding communication node. In this way, in the multi-hop-based communication network, the secondary trust head 702 may perform access control for the communication node located within the wireless communication radius of the secondary trust head 702, thereby providing an access control boundary 702-1.

In such the multi-hop based communication network, the unauthenticated communication node 706 may transmit attack traffic to the authenticated communication node 705 or the primary trust head 701. Here, the unauthorized communication node 706 may transmit attack traffic to the authenticated communication node 705 or the primary trust head 701 via the secondary trust head 702. However, since the secondary trust head 702 forms the access control boundary based on the wireless communication radius of the secondary trust head 702, the attack traffic transmitted from the unauthorized communication node can be blocked.

Meanwhile, in the multi-hop-based communication network according to the embodiment of the present disclosure, when the primary trust head 701 receives access request messages from a plurality of communication nodes at the same time, the primary trust head 701 may perform access controls for the plurality of communication nodes by starting the access control for the communication node present at the closest position from the primary trust head 701 among the plurality of communication nodes. Then, the primary trust head 701 may configure at least one function among the plurality of functions for the authentication procedure to be performed by a communication node according to the order of accessing the communication network through the access control. That is, the primary trust head 701 may configure a communication node to perform the role of the secondary trust head by configuring at least one function among the plurality of functions for the authentication procedure to be performed at the communication node, and the communication node may be determined in accordance with the order of accessing the communication network.

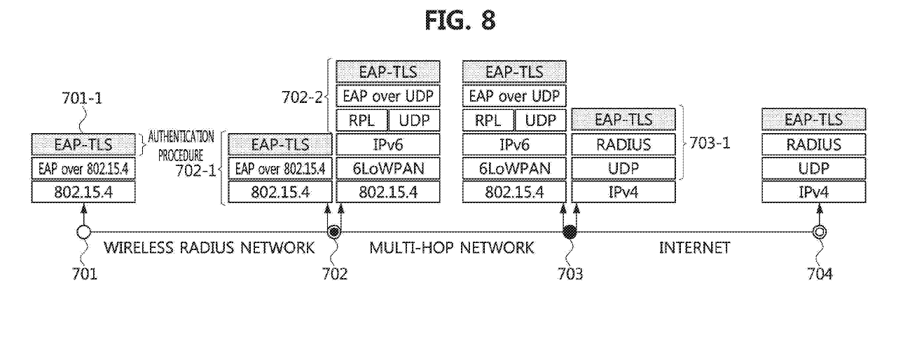

In the multi-hop-based communication network according to the embodiment of the present invention, protocol stacks of the primary trust head 701, the secondary trust head 702, the authentication server 703, and the new communication node 704 will be described concretely with reference to FIG. 8 below.

FIG. 8 is a conceptual diagram illustrating protocol stacks for access control in a multi-hop based communication network according to an embodiment of the present disclosure.

Referring to FIG. 8, a multi-hop based communication network according to an embodiment of the present disclosure may include the primary trust head 701, the at least one secondary trust head 702, the authentication server 703, and the new communication node 704 which have been described with reference to FIG. 7. Specifically, the new communication node 704 may transmit an access request message requesting access to the communication network based on a MAC level 802.15.4 wireless communication (referred to as a ‘wireless radius network’ in FIG. 8). The secondary trust head 702 may then transmit an access request message requesting access of the new communication node 703 to the primary trust head 701 through the multi-hop based network. In this case, the access request message may be transmitted based on a UDP-based application level in the IPv6 RPL-based multi-hop network. Then, the primary trust head 701 may transmit an access request message to the authentication server 703 via the Internet, requesting access of the new communication node 701.

As illustrated in FIG. 8, an Extensible Authentication Protocol-Transport Layer Security (EAP-TLS) based authentication scheme may be applied to the multi-hop communication network according to an embodiment of the present disclosure. Also, as for a carrier protocol for each section of data used in the authentication scheme, the MAC level may be applied between the new communication node 701 and the authentication server 703. Further, the application level may be applied between the secondary trust head 702 and the primary trust head 701 and between the primary trust head 701 and the authentication server 703. Further, the secondary trust head 702 and the primary trust head 701 may have a dual stack so that data used in the authentication scheme can be changed to a different level of the transfer protocol.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a first communication node performing access control in a multi-hop based communication network, the operation method comprising:
receiving a first message requesting authentication for a third communication node from a second communication node included in the communication network;
transmitting a second message requesting authentication for the third communication node to a fourth communication node performing an authentication procedure in the communication network;
receiving a third message from the fourth communication node, the third message including information on a result of the authentication procedure for the third communication node; and
transmitting a fourth message including the information on the result of the authentication procedure to the second communication node.

2. The operation method according to claim 1, wherein the first communication node is a primary trust head performing a plurality of functions for the authentication procedure in the communication network.

3. The operation method according to claim 1, wherein the second communication node is a secondary trust head performing at least one preconfigured function among a plurality of functions for the authentication procedure in the communication network.

4. The operation method according to claim 1, wherein the second communication node is a communication node for which an authentication procedure in the communication network has been completed in advance, and which is connected to the communication network.

5. The operation method according to claim 1, wherein the third communication node is a new communication node transmitting a message requesting access to the communication network to the second communication node.

6. The operation method according to claim 1, wherein the fourth communication node is an authentication server for performing the authentication procedure for the third communication node in the communication network.

7. An operation method of a first communication node performing access control in a multi-hop based communication network, the operation method comprising:
receiving a first message requesting access to the communication network from a second communication node;
transmitting a second message requesting authentication for the second communication node to a third communication node performing an authentication procedure;
receiving a third message from the third communication node, the third message including information on a result of the authentication procedure; and
determining whether to allow the second communication node to access the communication network based on the information on the result of the authentication procedure.

8. The operation method according to claim 7, wherein the first communication node is a secondary trust head performing at least one preconfigured function among a plurality of functions for the authentication procedure in the communication network.

9. The operation method according to claim 7, wherein the first communication node communicates with the third communication node based on a medium access control (MAC) level authentication protocol.

10. The operation method according to claim 7, wherein the second communication node is a new communication node transmitting the first message requesting access to the communication network to the first communication node.

11. The operation method according to claim 7, wherein the third communication node is a primary trust head performing a plurality of functions for the authentication procedure in the communication network.

12. The operation method according to claim 7, wherein, in the determining, when the authentication for the second communication node is successful, the second communication node is determined to be allowed to access the communication network.

13. The operation method according to claim 7, wherein, in the determining, when the authentication for the second communication node is not successful, the second communication node is determined to be not allowed to access the communication network.

14. An operation method of a first communication node performing an access procedure in a multi-hop based communication network, the operation method comprising:
discovering a second communication node to which access to the communication network is to be requested among a plurality of communication nodes included in the communication network;
transmitting a first message requesting access to the communication network to the discovered second communication node; and
receiving a second message including information on whether or not the first communication node is allowed to access the communication network from the second communication node.

15. The operation method according to claim 14, wherein the second communication node is a secondary trust head performing at least one preconfigured function among a plurality of functions for the authentication procedure in the communication network.

16. The operation method according to claim 14, wherein, in the discovering, a plurality of communication nodes located within a radius of a wireless communicable of the first communication node are attempted to be discovered.

17. The operation method according to claim 15, wherein the wireless communication is a medium access control (MAC) level frame-by-frame communication performed in the communication network.

18. The operation method according to claim 14, wherein the second message includes one of an indicator that allows the access to the communication network and an indicator that does not allow the access to the communication network.
